(19) United States
(12) Patent Application Publication
(10) Pub. No.: US 2008/0229612 A1
(43) Pub. Date: Sep. 25, 2008

(54) Human wearable laminar structure, insole made therefrom and methods for their manufacture

(75) Inventors: Renee Sommer, Bellevue, WA (US); Jeanee Petree, Bellevue, WA (US)

Correspondence Address: ATER WYNNE LLP, 222 SW COLUMBIA, SUITE 1800, PORTLAND, OR, 97201-6618, US

(73) Assignee: PoshPeds Incorporated

(21) Appl. No.: 12/077,932

(22) Filed: Mar. 21, 2008

Related U.S. Application Data
(60) Provisional application No. 60/919,598, filed on Mar. 22, 2007.

(51) Int. Cl. A43B 13/38; B32B 38/10

(52) U.S. Cl. 36/44; 156/250; 36/43

(57) ABSTRACT

A composite laminar structure treated to inhibit micro-organisms from thriving thereupon, comprising a suitable thickness of two or more expanses of woven or non-woven materials. A plurality of nano-particles, including materials such as silver, are distributed relatively uniformly across and sufficiently durably coupled with the two or more material expanses to resist removal during normal use and mild laundering. The nano-particles possess anti-microbial properties suitable to substantially inhibit population growth of one or more micro-organisms. The laminar structure may be configured as an insole for a shoe, or as other articles for wear or use in other applications where growth of micro-organisms is undesirable.

### RELATED APPLICATIONS

This application claims the benefit of priority to U.S. Provisional application No. 60/919,598, filed on 22 Mar. 2007 and entitled ANTI-MICROBIAL, ANTI-BACTERIAL AND/OR ANTI-FUNGAL HYPOALLERGENIC LAMINAR STRUCTURE, INSOLE MADE THEREFROM AND METHODS FOR THEIR MANUFACTURE, the contents of which are hereby incorporated herein in their entirety by this reference.

### BACKGROUND OF THE INVENTION

This invention relates generally to the field of insoles for footwear, e.g. shoes, boots, sandals, flip flops, slippers, and the like. More particularly, it concerns a composite, e.g. laminar, structure and insole made therefrom utilizing hypoallergenic materials that exhibit anti-microbial, anti-bacterial and/or anti-fungal properties.

### BRIEF DESCRIPTION OF THE DRAWINGS

FIG. 1 is an isometric fragmentary view of a laminar structure made in accordance with one embodiment of the invention.

FIG. 2 is a schematic diagram illustrating a part of the invented method of manufacturing the laminar structure of FIG. 1, including the treatment of a length of fabric in a colloidal nano-silver bath.

FIG. 3 is a flowchart of the steps in the method of manufacturing and using the invented insole in accordance with one embodiment of the invention.

FIG. 4 is an isometric view of a woman's dress shoe insole made of the laminar structure of FIG. 1.

FIGS. 5A, 5B, 5C and 5D collectively and respectively are four alternative top plan views of insoles for a woman's ¾ length mule shoe, a woman's sport or casual shoe or boot, a man's shoe or boot and a child's shoe or boot.

### DETAILED DESCRIPTION OF THE PREFERRED EMBODIMENTS

Briefly, the present invention provides a composite, e.g. laminar, structure and an insole made therefrom exhibiting antimicrobial, antibacterial and/or antifungal characteristics. The antimicrobial, antibacterial and/or antifungal effects (collectively herein in any combination ‘antimicrobial’) of the composite insole are derived from nano-silver particles that are infused or otherwise ingrained in, or effectively applied to a surface of, the composite material. The composite insole material layer (‘fabric’ herein for convenience) contains fibers made of cotton, linen, silk, wool, leather, blended fabric, synthetic fiber, or any combination thereof The present invention also provides a method for constructing the antimicrobial, antibacterial and/or antifungal composite insole.

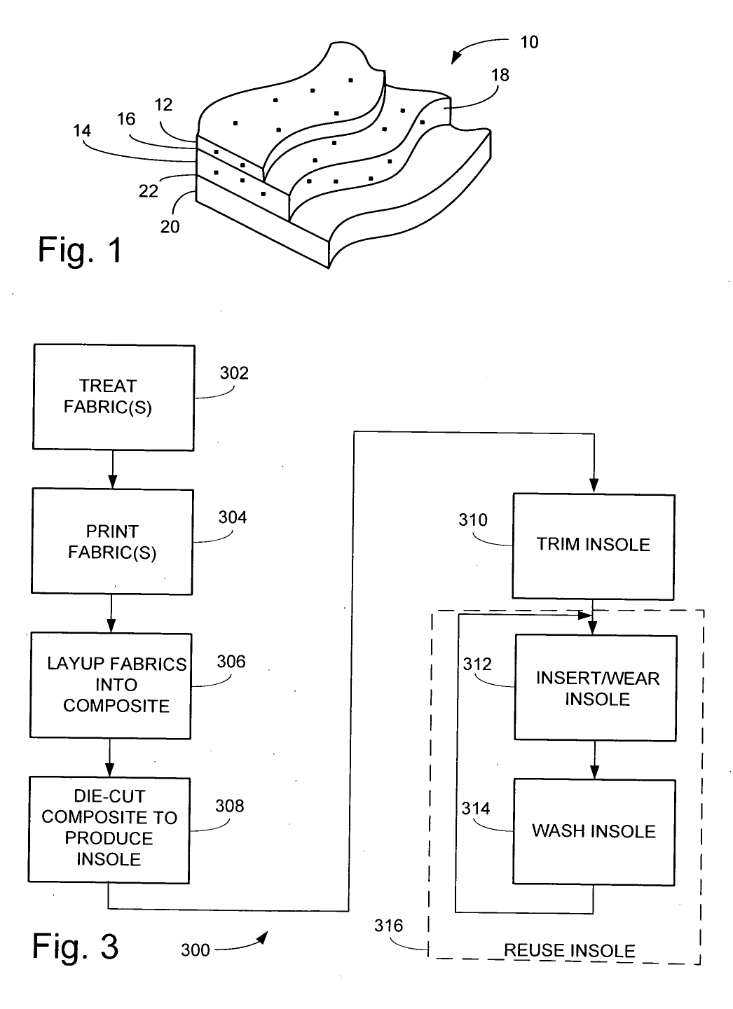

FIG. 1 is an isometric fragmentary view of the invented composite, e.g. laminar, structure 10 made in accordance with one embodiment of the invention. Those of skill in the art will appreciate that generally planar laminar structure 10 is configured to provide antimicrobial, antibacterial, and/or antifungal properties, preferably to be at least hand-washable, and to be relatively soft and comfortable against a user's skin. More particularly, those of skill will appreciate that the laminar structure 10 is provided with an upper laminate 12 of finished material such as woven cotton and an intermediate laminate 14 of body fluid-affinitive or so-called “wicking” material such as woven wool. In accordance with one embodiment of the invention, laminates 12 and 14 are adhered to one another by a thin and preferably moisture-permeable film adhesive layer 16, as illustrated, which can be obtained from the 3M™ Corporation, although embodiments contemplate the use of suitable alternatives. Adhered laminates 12 and 14 are referred to herein as the invented composite, however adhered to one another, and whether “backed” or “fronted” by another laminate. Each of upper laminate 12 and intermediate laminate 14 may typically be configured as an expanse of material, each having at least two opposing relatively planar surfaces lying approximately parallel planar with respect to one another.

In accordance with one embodiment of the invention, one or more of laminates 12 and 14 include, e.g. are infused or otherwise effectively treated with, a suitable density of colloidal nano-particles 18 exhibiting anti-microbial, anti-bacterial, and/or anti-fungal properties. Colloidal nano-silver has been shown to be one such colloidal nano-particle and can be made to substantially permanently infuse or otherwise ingrain a cotton fiber and/or a wool fiber of which laminates 12 and 14 suitably can be made. Nano-silver with a mean particulate diameter of between two and five nanometers (2-5 nm) has been found to be capable of being substantially evenly distributable throughout both fibrous layers, thereby substantially permanently to render laminar structure 10 anti-microbial, anti-bacterial and antifungal. The embodiments are not, however, so limited. For example, colloidal silver particles with cross-sectional dimensions of approximately 11.6 nm, 30 nm, and 70 nm have shown demonstrated anti-microbial efficacy. Although nano-silver is described in embodiments herein, other materials shown to provide anti-microbial properties include zinc, copper, and others, which may also be formed as nano-particles and applied as described herein.

In general, colloidal solutions including silver nano-particles with suitable cross-sectional (e.g. diametric) dimensions between approximately 2 nanometers and approximately 150 nanometers (˜2-150 nm.) provide similar benefits (e.g., anti-microbial, etc.), and effective embodiments are likewise contemplated herein at even larger sizes. It is, however, expected that particle size can affect some performance characteristics, such as particle distribution upon and/or throughout layers in a laminate structure described herein, and particle retention during laundering, for example, with small particles providing enhanced benefits and performance characteristics relative to larger particles.

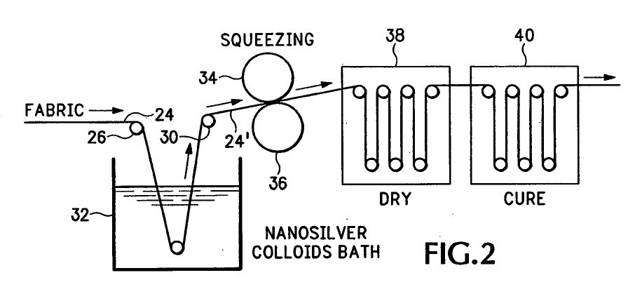

Effective diffusion and even dispersion of the nano-silver particles in accordance with one embodiment of the invention is achieved by soaking the laminates in a nano-silver-infused bath and then drying the same, as will be discussed in more detail below by reference to FIG. 2. Alternative means or methods of effectively impregnating or otherwise suitably ingraining or surface treating (as by printing with colloidal nano-silver ink or dye) the composite, e.g. laminar, structure with colloidal nano-particles are within the spirit and scope of the invention.

Those of skill in the art will appreciate that alternative composite materials may be substituted, e.g. linen, silk, leather, blending fabric, synthetic fiber such as a “wicking” polyester, or the like, alone or in combination. Thus, while a cotton upper and a wool lower laminate are described and illustrated here because of their hypoallergenic, smoothness and comfort qualities, those of skill in the art will appreciate that other suitable fibers or materials made by any suitable process nevertheless are within the spirit and scope of the invention. For example, woven fibers such as “wicking” polyester can be substituted for the cotton upper laminate to “dry wick” body fluid (e.g. sweat) away from the user's body.

Optionally, a third laminate substrate 20 lies beneath and supports the above-described composite structure including laminates 12 and 14. Substrate 20 can be of any suitable material such as hydrogel, silicone, Ellastalloy™, Kraton™, or the like (e.g. a special formulation may be created for this layer using a combination of Kraton and another polymer). For particular applications, such as shoe insoles to be described below, it may include an inherent non-slip or non-skid lower surface or a lower surface suitably treated to be non-slip or non-skid. Depending upon the material from which it is formed, substrate 20 may naturally ‘cling’ to laminate 14 or it may instead be more permanently adhered thereto with any suitable adhesive, e.g. an adhesive film layer 22.

Those of skill in the art will appreciate that FIG. 1 is not drawn to scale in terms of dimensions, especially the relative thicknesses of the laminates. Nor is FIG. 1 drawn to scale in terms of the density of the nano-silver particles (shown as tiny dots in laminates 12 and 14). Any relative thicknesses of laminates 12 and 14 and optional laminate 20 and particulate densities within composite 10 that are effective for their intended purpose are contemplated as being suitable and within the spirit and scope of the invention.

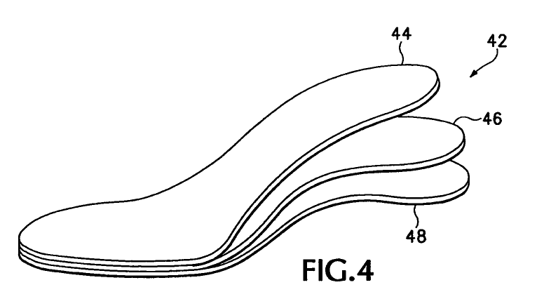

FIG. 2 is a schematic diagram depicting a step of the invented method of manufacturing the laminar structure of FIG. 1, discussed above, and/or the shoe insole of FIG. 3, discussed below. Initially dry material/fabric 24 is conveyed via rollers 26, 28 and 30 through a nano-silver colloids bath 32 to impregnate fabric 24 with colloidal nano-particles 18 (refer to FIG. 1). The impregnated or infused fabric 24′ is then squeezed between closely adjacent squeeze rollers 34 and 36. Impregnated fabric 24′ is dried in a heated drying station 38 and cooled and relaxed in a curing station 40. Those of skill in the art will appreciate that fabric 24 and 24′ refers generally in this process diagram to any fabric, e.g. laminate 12 and/or laminate 14, that is to be nano-silver impregnated.

In accordance with one embodiment of the invention, the processing conditions are as follows. The bath includes 2-3% by volume of a nonionic or cationic softening agent such as fabric softener, 0.5-1% by volume of a wetting agent and approximately 5-5.5% by volume (i.e. approximately 50-55 grams/liter (g/L) of nano-silver-containing colloidal fluid identified by the trade name SNSE, or another suitable nano-silver colloid volume. SNSE is available from the NP-Tech Co. Ltd. of Seoul, South Korea, but any suitable alternative is acceptable. The pick-up ratio of the process, i.e. the wet weight contribution to the fabric from the bath, is approximately 55-60%. The pick-up ratio is pre-tested to ensure proper pick up or percentage saturation of the fabric by the bath solution by adjustment, for example, of the pressure between squeeze rollers 34 and 36. Drying and curing stations 38 and 40 can be of conventional design, e.g. typically the dryer has a peak temperature of approximately 130° C. in the middle with temperatures tapering toward the entrance and exit thereof.

FIG. 3 is a flowchart depicting the steps in the manufacture and use of the invented insole in accordance with one embodiment of the invention. From FIG. 3, one or more of the two fabrics for laminate 12 and 14 is infused or impregnated or otherwise effectively treated at 302 with colloidal nano-silver, as by the process briefly outlined above by reference to FIG. 2. At 304, the upper surface of the impregnated fabric for laminate 12 optionally is printed, as with a designer name, logo, etc. At 306, laminates 12, 14, and 20 are laid up and adhered to one another. At 308, the composite or laminar structure 10 is die-cut to produce a desired shoe insole outline and edge compression thereat, although alternative methods for separating an insole from the composite/laminar structure 10 are also contemplated in embodiments. Those of skill in the art will appreciate that blocks 302, 304, 306 and 308 are manufacturing steps, and the order of such steps can be altered (e.g., printing fabrics after lay-up, etc.) without departing from the contemplated embodiments.

Those of skill in the art will appreciate that the manufacturing steps illustrated in FIG. 3 and described above can be omitted, changed, differently ordered and/or combined and/or separated into smaller steps. For example, within the spirit and scope of the invention, the treat and print steps 302 and 304 can be combined. In accordance with one embodiment of the invention, colloidal nano-silver is added to the paint that is used in the printing process on upper laminate 12 to treat the composite and to produce the desired anti-microbial, anti-bacterial, and/or anti-fungal properties. Thus, the invented composite and insole within the spirit and scope of the invention can have the colloidal nano-silver treatment on an upper (foot- or sock-contacting) surface of the upper laminate, or can have the colloidal nano-silver infused in the upper laminate itself, or can have the colloidal nano-silver infused in both the upper laminate and the intermediate laminate also. All such embodiments of the invention and their equivalents are contemplated.

At 310, the insole is trimmed by the user to fit his or her particular shoe size and style. At 312, the insole is inserted into the user's shoe, snugged against the inner flat surface thereof and worn (used). After one or more uses of the insole, at 314, the insole is washed, preferably by hand in cold water using a mild detergent such as that sold under the trade name WOOLITE™. At 316, the insole is reused, thus repeating insert/wear and wash blocks 312 and 314. Experimental results indicate that twenty or more (e.g. fifty) reuses of the same insole are possible in accordance with the invention.

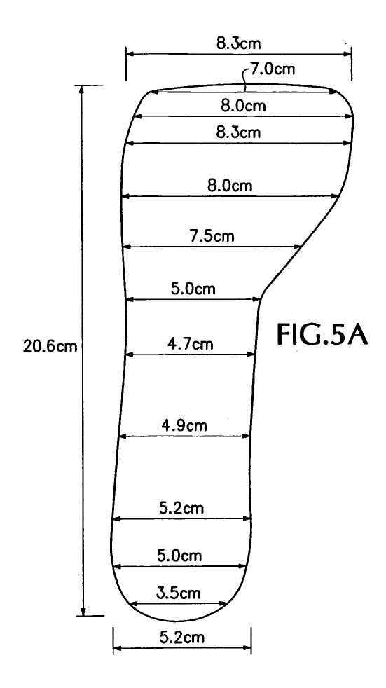

FIG. 4 is an isometric view of a woman's dress shoe insole 42 made of the laminar structure of FIG. 1. In view of the above description, the structure of insole 42 is nearly self-explanatory. Insole 42 includes a top designer layer 44, an intermediate layer 46, and a bottom non-slip or non-skid layer 48, all cut to a desired size and style of a woman's dress shoe (not shown) and all adhered to one another to produce a composite insole. Importantly, at least layer 44 is nano-silver particulate infused or treated (as by the infusion process described and illustrated herein or as by application by whatever means of an outer surface layer). In accordance with one embodiment of the invention, intermediate layer 46 also is similarly or identically infused or treated. The result is an insole for inserting in the bottom of a shoe, the insole being characterized as anti-microbial, anti-bacterial, and anti-fungal. Experimental results indicate 99.9% effectiveness after between twenty and fifty uses against two bacteria including staphylococcus aureus and klebsiella pneumoniae.

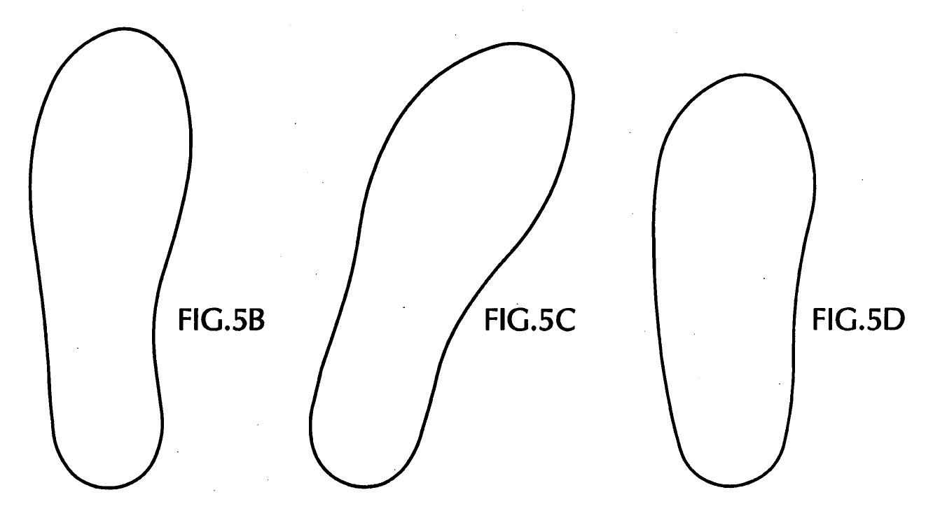

FIGS. 5A, 5B, 5C and 5D collectively are four alternative top plan views of insoles for a woman's ¾ length mule shoe, a woman's sport or casual shoe or boot, a man's shoe or boot and a child's shoe or boot. Those of skill in the art will appreciate that each of the four alternative insoles is slightly different in shape and size to accommodate the physiological and aesthetic preference differences among women, men and children. Those of skill also will appreciate that designer prints and/or autographs and/or logos of various configurations and patterns and colors can be added to the upper, visible surface of Top Designer Layer A, as illustrated, to promote various designer trade names such as GUCCI™, FENDI™, COACH™, BURBERRY™, KATE SPADE™, RALPH LAUREN™, etc. Alternatively, copyrighted proprietary graphics, logos, trademarks, symbols, phrases, or patterns can be printed on Top Designer Layer A for promotional, educational, entertainment or any other purpose. All such printing or surface preparation is contemplated as being within the spirit and scope of the invention.

Those of skill in the art will appreciate that FIGS. 5A-5D illustrate representative or generic template outlines for the insoles. Within the spirit and scope of the invention, different shapes (e.g. shorter or partial insoles) or sizes (e.g. S/M/L/XL) may be provided. Alternative versions might include a women's dress shoe/pump or ¾ length mule insole; a women's sport or casual full length shoe or boot; a men's full-length shoe or boot; a children's shoe or boot; a women's, men's or children's open-toed sandal or slipper, etc. All such alternative shapes and sizes and styles of insoles for use in a wide variety of footwear are contemplated and are within the spirit and scope of the invention.

Those of skill in the art will appreciate that the invented composite, e.g. laminar, structure lends itself to applications other than footwear. For example, general or specific attire or garments, e.g. riding breeches, athletic wear, hats, gloves, halters, pants, tops, etc. can be made using the composite with the advantage of its novel antimicrobial properties. Indeed, any non-woven or woven or other organic or natural materials such as cotton, wool, silk, leather, polyester, or the like can be made into the invented composite and the composite can then be made into any desirable shape for any desirable purpose. All such applications are contemplated as being within the spirit and scope of the invention.

### One Embodiment of the Invention

In accordance with one embodiment of the invention, top designer layer 44 is made of woven 100% cotton fiber. Also in accordance with one embodiment of the invention, the top designer layer 44 is fused to a 100% wool central padded layer 46 with an adhesive film therebetween (for example, the earlier described adhesive available from the 3M™ corporation, or a suitable alternative). In accordance with one embodiment of the invention, both layers 44 and 46 are treated with “permanent” colloidal nano-silver by which is meant the treatment lasts substantially indefinitely under normal use and reuse. Finally, in accordance with one embodiment of the invention, the bottom layer 48 is made of non-slip hydrogel, silicone, the material identified by the trade name ELASTALLOY™, the material identified by the trade name KRATON™, or other suitable material that ‘sticks’ to the surface of an original shoe footbed without slipping or leaving a residue. Those of skill in the art will appreciate that top designer layer 44 typically is of lighter weight than is central padded layer 46, which typically is of lighter weight material than is bottom layer 48.

In accordance with one embodiment of the invention, top layer 44 is suitably approximately 1/64- 1/32 inch thick, intermediate layer 46 is suitably approximately 1/16-⅛ inch thick, and bottom layer 48 is suitably approximately 1/16-⅛ inch thick, all measured in their uncompressed states. Those of skill in the art will appreciate, however, that the laminates are relatively fluffy and yieldable, and that, when compressed, an inner region tri-laminate composite insole typically is no thicker than approximately 1/16-⅛ inch, and that, along the peripheral edge, the composite insole typically is no thicker than approximately 1/32 inch. Those of skill in the art will also appreciate that the weights of the various layers, within the spirit and scope of the invention, may be different whether absolutely or relatively.

If orthotic effects are desired, such can be accommodated in accordance with the invention by modifying bottom layer 48. For example, an arch support can be built, e.g. molded, into a special bottom layer 48 before bottom layer 48 is adhered to the other two layers 44 and 46 of insole 42. Any and all such modifications to the laminates of the composite insole, whether functional (e.g. orthotic), or aesthetic, are contemplated as being within the spirit and scope of the invention.

There are four style/shape templates for this insole, Women's Dress, Women's Sport or Casual, Men's and Children, although those of skill in the art will appreciate that any number of styles and shapes are contemplated as being within the spirit and scope of the invention.

### Shoe Insole Product Characteristics in Accordance with the One Embodiment

1. Fiber layers are constructed of natural, environment-friendly, hypoallergenic materials.

2. Non-slip bottom layer 48 is a hydrogel, silicone, ELASTALLOY™ or KRATON™ layer that ‘sticks’ (naturally or as by the application of heat to the interface between bottom layer 48 and intermediate layer 46) to the original insole surface of the shoe or boot without slipping.

3. Non-slip bottom layer 48 is re-usable, repositionable without losing adhesive quality.

4. Non-slip bottom layer 48 is removable without leaving residue on the upper surface of the shoe's inside bottom.

5. Non-slip bottom layer 48, once adhered within the invented insole 42, is not water soluble, nor will it break down or dissolve if soaked in water with mild laundering detergent (e.g., WOOLITE™, and/or other hand-washing detergent).

6. Insole 42 is washable up to approximately twenty washings or more (hand washing recommended), and repositionable after washing with same level of original adhesion.

7. Edges of insole 42 are compressed to a very thin (≦ 1/32″) clean finish.

8. Insole 42 is ‘trim-able’ within ¼″ at the perimeter of the insole for adjustments to size and fit in the shoe or boot.

9. At least top layer 44 and optionally also the wool padded center layer are treated with a solution of colloidal nano-silver particulate 18 with a mean diameter of the silver particles of between 2-5 nm.

10. The application of nano-silver particulate 18 is permanent and will not lose anti-microbial, anti-bacterial, anti-fungal efficacy for up to twenty or more washings.

11. Distribution of nano-silver particles 18 on fabric (as a function of weight per square centimeter) is provided in a suitable concentration of parts per million (ppm) proven effective in eliminating micro-organisms (e.g., one or more of bacteria, fungus, microbes, etc.) to a 95% or greater level, more preferably up to a 99.7% or greater level and, in accordance with some embodiments, even up to a 99.9% level. Demonstrated suitable concentrations are found in the range of approximately 10-200 ppm. While it is expected that even higher concentrations may provide improved particle density when deposited on an expanse of material suitable for use in a laminar insole described herein, and therefore perhaps enhanced anti-microbial benefits, and improved particle retention following laundering, concentrations of silver nano-particles in the range of approximately 20-50 ppm have shown particular benefits.

12. Bottom non-slip layer 48 is protected by a suitable film cover material such as a biaxially-oriented polyethylene terephthalate (boPET) polyester (identified by the trade name MYLAR™), acetate or another comparable removable material to prevent insole 42 from sticking to the inside of the insole's packaging. Such cover material may typically be clear, although it may likewise be partially or entirely opaque to light in the visible spectrum according to alternative embodiments. Likewise, the cover material may be treated with a release material (e.g., silicone, etc.) to enable easy release from the bottom non-slip layer 48.

13. To use insole 42, the MYLAR™ cover is peeled away, exposing the sticky non-slip lower surface of the bottom layer.

14. Finished insole 42 is die-cut to pattern sizing specifications.

### Alternative Embodiments

The scope of the invention contemplates several variations which yield useful and beneficial properties in alternative embodiments.

In one such embodiment, one or more of the laminate materials can comprise aromatic (e.g., in the broad sense of having an aroma) or other fragrant materials. For example, a laminate material individually or when combined with another laminate material, or an adhesive material utilized in construction of a laminar structure described herein, may be infused with essential oils, or may include an integrated fragrant material (e.g., fragrant portions of a lavender plant, etc.). The fragrant material may be a naturally occurring material or some derivative thereof, or a man-made fragrant material, or any combination thereof. By ‘fragrant material’, it is meant that the material inherently and/or is caused to release into the surrounding environment (e.g., whether gaseous, liquidous, etc.) compounds which individually or in combination are detectable by the olfactory organs of any living organism. Thus, a laminar structure which exudes a pleasant aroma for humans, as well as a laminar structure which exudes an offensive smell to one or more animals (for example, to discourage a dog from chewing slippers), are equally within the scope of the contemplated embodiments.

Another contemplated embodiment provides a laminar structure in which one or more of the laminate materials include pharmaceutically and/or physiologically beneficial materials (e.g., medicines, soothing lotions/oils, anti-pruritics, anti-biotics, ultraviolet-energy blockers, etc.), configured to deliver a beneficial effect to a human. Such effect can be deliverable at the time a laminar structure so configured is worn, however in embodiments, residual beneficial effects may continue for some period of time even after removal by the human. For example, an approved and recognized anti-fungal compound can be infused, applied, embedded, or otherwise incorporated with a laminate structure, and while the nano-particles of the laminate structure inhibit microbial growth at the laminar structure itself, the anti-fungal compound can deliver similar benefits to a wearer of the laminar structure. Therefore, an embodiment of the invented laminar structure can not only mitigate the harmful potential of a common vector for harmful micro-organisms (e.g., a shoe insole, etc.), but can also deliver medication and treatment to a human wearer via the inclusion of a recognized and approved medicinal material. However, the embodiments are not so limited, and can generally include any pharmaceutically and/or physiologically beneficial material or compound, or combination thereof, which provides benefits when placed in contact and/or proximity to a portion of a human body.

Further, although numerous material for forming a woven or non-woven laminate material are listed herein, it bears repeating and clarifying that the embodiments are in no way limited to the listed materials. The contemplated embodiments include both natural and synthetic materials, or any suitable combination thereof. A non-exclusive list of natural material can include cotton, silk, bamboo, hemp, wool, or hair, but more properly encompasses any material obtained and/or derived from natural sources, whether obtained or formed as fibers or in some other form. Likewise, the vast number of options utilizing synthetic materials (e.g., man-made or machine-made) provide embodiments far too numerous to list. As any listing provide herein could be improperly interpreted in a limiting sense, no such listing is provide. However, one having skill in the art will recognize that nearly any synthetic material currently used or contemplated for use in the production of or formable as textiles, fabrics, or other flexible sheet-like materials may be used in embodiments as provided herein. Additionally, the term ‘man-made’, wherever utilized within this description, is not intended exclude materials which are partially or entirely machine-made, but rather is used herein to mean any material which is altered in some way from a naturally occurring state, by whatever method.

Likewise, any materials formed by utilizing, converting, reforming, reusing, reintegrating, reconstituting, or otherwise recovering previously used materials, whether natural, synthetic, or some combination thereof, are expressly included within embodiments and the scope of the contemplated invention. Collectively, all such material are considered ‘recycled materials’, but this phrase is given a most expansive meaning herein, and is not limited by any commercial, industrial, scientific, or other ‘special meaning’ assigned to the phrase ‘recycled materials’, past, present, or future. Rather, the phrase ‘recycled materials’ is used herein to means any material which was intended or actually applied to any past use, regardless the nature or term of that use, and is subsequently utilized in a laminar structure as described herein.

It will be understood that the present invention is not limited to the method or detail of construction, fabrication, material, application or use described and illustrated herein. Indeed, any suitable variation of construction, fabrication, material, use, or application, or any equivalent thereof, is contemplated as an alternative embodiment, and thus is within the spirit and scope, of the invention.

From the foregoing, those of skill in the art will appreciate that several advantages of the present invention include the following.

The present invention provides anti-microbial, anti-bacterial, and/or anti-fungal properties in a fabric composite and in a footwear insole. The insole's composite structure encourages wicking away from the user's foot of sweat or other body moisture to keep the foot dry. The composite's smooth upper layer is smooth and comfortable against the foot. The insole is washable and reusable, but maintains its effectiveness, integrity and durability through multiple washings. The insole is aesthetically pleasing, and its smooth upper (visible) surface can bear designer names or logos or other proprietary print graphics, patterns, and/or colors.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A composite in-sole structure treated to inhibit micro-organisms from thriving thereupon, comprising:
a first relatively planar material expanse of a suitable thickness, the first material expanse having a first surface and an opposing second surface, the material expanse having an outer periphery configured to approximately correspond to a periphery of all or some portion of a sole of a human foot;
a second relatively planar material expanse of a suitable thickness, the second material expanse having a third surface and an opposing fourth surface, wherein a substantial portion of the third surface is adhesively coupled with a corresponding portion of the second surface and is approximately coextensive therewith, the adhered material expanses forming a multi-layer laminate structure; and
a plurality of nano-particles distributed relatively uniformly across and sufficiently durably coupled with one or both of the first material expanse and the second material expanse to resist removal during normal use and mild laundering, the nano-particles possessing anti-microbial properties suitable to substantially inhibit population growth of one or more micro-organisms.

2. The composite in-sole structure of claim 1, further comprising:
a third material expanse having a fifth surface and an opposing sixth surface, wherein a substantial portion of the fifth surface is adhesively coupled with a corresponding portion of the fourth surface and is approximately coextensive therewith.

3. The composite in-sole structure of claim 2, wherein one or more of the first material expanse, the second material expanse, and the third material expanse comprises one or more of a non-woven material, a hypo-allergenic material, a fragrant material, a recycled material, a natural material, and a material having either pharmaceutically or physiologically beneficial properties for humans.

4. The composite in-sole structure of claim 1, wherein the nano-particles comprise silver and are provided in a suitable concentration to substantially inhibit microbial-growth either or both of upon and within the multi-layer laminate structure.

5. The composite in-sole structure of claim 1, wherein the nano-particles are suitably-sized with a cross-sectional dimension in a range of approximately 2-150 nanometers.

6. The composite in-sole structure of claim 1, further comprising:
a layer of a first adhesive material interposed between and adhesively coupling the second surface with the third surface, wherein the adhesive material is permeable to moisture.

7. The composite in-sole structure of claim 1, wherein one or more of the first material expanse and the second material expanse comprises a moisture-wicking material.

8. The composite in-sole structure of claim 2, further comprising:
a relatively planar fourth expanse of liner material positioned adjacent to the sixth surface, the expanse of liner material having a seventh surface and an opposing eighth surface, the seventh surface being adhesively coupled with the sixth surface by a relatively thin layer of a second adhesive material, the seventh surface further being removable from the second adhesive material while leaving the second adhesive layer reasonably intact at the sixth surface.

9. The composite in-sole structure of claim 1, wherein the first material expanse further comprises one or more of text, symbols, graphics, logos, trademarks, symbols, phrases, and patterns, printed at the first surface or otherwise visibly incorporated with the first material expanse.

10. The composite in-sole structure of claim 2, wherein a thickness of a portion of the third material expanse differs relative to a thickness of another portion of the third material expanse.

11. The composite in-sole structure of claim 2, wherein the third material expanse comprises a material configured to provide a typically reusable, non-slip interface with a footbed of a shoe when positioned in intimate contact therewith, while also being removeable therefrom without leaving an appreciable residue thereupon, such material being one more selected from the group consisting of a hydrogel, a silicone, a material identified by the trade name ELASTALLOY, a material identified by the trade name KRATON, and any suitable substitute.

12. A method of providing a composite insole structure treated to inhibit micro-organisms from thriving thereupon, comprising:
relatively uniformly depositing an operative concentration of nano-particles of a microbial-growth-inhibiting material at an operative portion of a relatively planar expanse of a first material;
adhesively coupling a relatively planar expanse of a second material with the operative portion of the first material expanse in a relatively parallel-planar arrangement, the adhesively-coupled first and second material expanses comprising a multi-layer laminar structure; and
separating from the laminar structure a portion approximately corresponding in each of size and perimeter contour to a portion of a human foot, wherein the first and second material expanses are approximately co-extensive one with the other.

13. The method of claim 12, further comprising:
increasing the layers of the multi-layer laminated insole structure by adhering an expanse of a third material with the insole structure, wherein one of the operative portion of the first material expanse and the second material expanse is interposed between the third material expanse and the other of the operative portion of the first material expanse and the second material expanse.

14. The method of claim 12, wherein depositing nano-particles comprises immersing the operative portion of the first material expanse in a colloidal solution comprising a suitable concentration of silver nano-particles, and further comprising one or more of water, ethanol, approximately 2-3% by volume of a softening agent, and approximately 0.5-1% by volume of a wetting agent.

15. The method of claim 12, wherein relatively uniformly depositing nano-particles comprises controlling a pick-up ratio of colloidal solution by providing a plurality of corresponding squeeze rollers, passing the first material expanse between the squeeze rollers after the first material emerges from the colloidal solution, and adjusting an amount of force concurrently applied to the first material by the corresponding squeeze rollers as it passes therebetween.

16. The method of claim 12, further comprising:
relatively uniformly depositing an operative concentration of nano-particles of a microbial-growth-inhibiting material at an operative portion of the second material expanse.

17. The method of claim 12, further comprising:
printing or otherwise visibly providing at an exposed surface of the insole structure one or more of text, symbols, graphics, logos, trademarks, symbols, phrases, and patterns.

18. The method of claim 12, further comprising:
configuring the insole structure with moisture-wicking properties by either or both of:
providing one or both of a moisture-wicking first material expanse and a moisture-wicking second material expanse, and
providing a layer of moisture-permeable adhesive material interposed between the first material expanse and the second material expanse.

19. The method of claim 13, further comprising:
configuring the third material expanse with at least a first thickness at a first portion and a second thickness at a second portion, wherein the plurality of thicknesses are configured to provide the insole structure with one or more beneficial characteristics non-exclusively selected from among;
providing additional thermal insulation at a portion of a human foot placed thereupon,
providing additional support at a portion of a human foot placed thereupon,
providing additional cushion at a portion of a human foot placed thereupon,
improving a level of correspondence between a contour of a footbed of a shoe and a contour of a human foot placed thereupon,
providing orthotic benefits,
altering the aesthetic characteristics of either or both of a shoe or a human leg upon the lower terminus of which the insole is positioned during use, and
preventing slippage of a human foot relative to a footbed of a shoe due to a lateral force applied therebetween.

20. A human-wearable laminar structure, comprising:
two or more expanses of material configured in a composite laminar arrangement, each expanse having at least one relatively planar surface urged into and relatively securely retained in close relation with an adjacent relatively planar surface of at least one other material expanse of the arrangement; and
a suitable concentration of suitably-sized silver nano-particles distributed relatively uniformly across and coupled with one or more of the material expanses sufficiently durably to resist removal during normal use and at least approximately twenty cycles of mild laundering, the nano-particles provided in a suitable concentration to render the laminar structure substantially unsuitable for growth of one or more species of micro-organisms.
